(19) United States
(12) Patent Application Publication
(10) Pub. No.: US 2011/0313931 A1
(43) Pub. Date: Dec. 22, 2011

(54) VIRTUAL SUPPORT CONTRACT COLLABORATION

(75) Inventors: David BRONSTEIN, ATLANTA, GA (US); Navin RAJARAM, AHMEDABAD (IN); Robert Rhea SEIBEL, WARETOWN, NJ (US)

(73) Assignee: AVAYA INC., BASKING RIDGE, NJ (US)

(21) Appl. No.: 12/821,010

(22) Filed: Jun. 22, 2010

(51) Int. Cl. G06Q 99/00; G06Q 10/00

(52) U.S. Cl. 705/80; 705/304

(57) ABSTRACT

A virtual contract system is provided that can collect contract information for one or more products or support services. The information can be collected from one or more data sources including from service databases, BP databases, from equipment memory, etc. The information may be organized into a single “virtual contract.” To promote discussion and agreement on renewal of support contracts, the same virtual contract is displayed to the supplier/servicer and to the BP/customer. The display or user interface allows the servicer and customer to negotiate and approve the renewal contract and to agree on the sale of new products or services. Upon completing the negotiation, the virtual contract system can save the data regarding the virtual contract to the several data sources.

### BACKGROUND

When selling products to customers, manufacturers or other organizations often provide a repair and maintenance services. These services generally are provided under a separate support contract that is renewed periodically. Completing support contract renewals generally requires a great amount of manual processing and can be fraught with problems. The negotiations are often inefficient. For example, business partner (BP) records are often out-of-date, especially concerning what new products the BP has added. Further, determining who is currently responsible to approve product support contracts is often difficult, as the responsible person at the BP often changes between renewal negotiations. Data is often entered into multiple billing systems manually, which is a time consuming and error prone task. Further, negotiating contract renewals can require time-consuming discussions that distract from new sale discussions.

Many product service providers use databases to track customers' purchases and which suite of products a service provider services. The service provider databases are often not updated as the customer adds and removes related products over the term of a support contract. Thus, the databases are frequently out-of-date, especially since the update activity requires manual cross-checking between the customer's and supplier's databases. In addition, manufacturers may end support on current products leaving the customer without support on a previously supported product. As a result, it is generally difficult to accurately renew a customer's contract because of the extent of product churn.

Further, other problems arise where customers are over-billed or under-billed, where service companies spend a great deal of time checking multiple databases, like SAP and licensing systems, where suppliers often must call the customer to determine what the customer has purchased, where the customer does not want support for a product any longer, where the customer does want other products covered, and where suppliers need to remove old products from the customers' systems if those products are no longer supported. Service companies share this problem with the customers today and waste the customers' time in getting the renewed support contract correct.

In some cases, the primary supplier of a customer solution is a reseller of that solution for another 3rd party provider, e.g., an original equipment manufacturer (OEM). The primary supplier is permitted to provide support to the end-user customer provided that the user also contracts with the OEM for support. The involvement of the several parties compounds the difficulties associated with maintaining accurate records between the customer and primary supplier and between the primary supplier and the OEM. All three entities should have consistent information as to what equipment is installed at the user and what support is contracted. When transactional product additions are purchased and added to the contract or when subsequent contracts require renewal, a lot of effort is expended checking databases and ensuring that all the parties agree on what exactly will be contracted.

Sales teams generally have a hard time finding the right person to contact for contract renewal. Customer representatives, originally listed as the responsible parties for contract renewals, may not be the correct person to renew the support contracts since those representatives often change during the term of the support contract, which can span one (1) to five (5) years. Thus, sales teams waste time finding the correct person instead of selling new products and services to the customer.

### SUMMARY

It is with respect to the above issues and other problems that the embodiments presented herein were contemplated. A virtual contract system is provided that can collect contract information for one or more products or support services. The information can be collected from one or more data sources including from service databases, BP databases, from equipment memory, licensing systems, etc. The information may be organized into a single “virtual contract.” To promote discussion and agreement on renewal of support contracts, the same virtual contract is displayed to the supplier/servicer and to the BP/customer. The display or user interface allows the servicer and customer to negotiate and approve the renewal contract and to agree on the sale of new products or services. Upon completing the negotiation, the virtual contract system can save and update the data regarding the virtual contract to the several data sources.

The virtual contract system can bring disparate product and support information together into a virtual collaboration environment where the customer and third-party support teams agree on what is purchased and what products are to be covered under a support contract. Subsequently, the virtual contract system can then save the agreed contract information back into and synchronize databases with up-to-date customer contact terms, representative names, and other data. The up-to-date information may be used in the future for the support notification and collaboration process.

The virtual contract system provides distinct advantages. For example, the virtual contract system integrates with the supported product to gather accurate customer contact information entered by the product administrator. Further, the virtual contract system can use the customer contact information to send product specific manufacturer information (like product support notices, e.g., end-of-product sale notices, end-of-manufacturers-support notices, end-of-services-support notices, etc.) to the right customer contact, who is able to act on the notices. The virtual contract system may also facilitate a collaboration process that can reconcile multiple support and billing databases making sure one support contract is agreed to by the customer and the support service provider.

The virtual contract system can be enabled to interface with third party OEM databases to enable record sharing between systems. This interface allows the primary supplier and the third party OEM to create rules for managing shared master data on installed base equipment and entitlements and to share that view with the end-customer.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The term “computer-readable medium” as used herein refers to any tangible storage that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, or any other medium from which a computer can read. When the computer-readable media is configured as a database, it is to be understood that the database may be any type of database, such as relational, hierarchical, object-oriented, and/or the like. Accordingly, the embodiments are considered to include a tangible storage medium and prior art-recognized equivalents and successor media, in which the software implementations are stored.

The terms “determine”, “calculate” and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element.

The term “contract” as used herein refers to any agreement that governs the terms and conditions for an association between a customer and servicer/seller of a product or service. In embodiments, the contract governs the support of a product sold to the customer.

While exemplary embodiments are described, it should be appreciated that individual aspects can be separately claimed.

### BRIEF DESCRIPTION OF THE DRAWINGS

The present disclosure is described in conjunction with the appended figures:

FIG. 1 is a block diagram of an embodiment of a system to negotiate a contract;

FIG. 2 is a diagram of an embodiment of a virtual contract system to negotiate the contract;

FIGS. 3A through 3E are diagrams of embodiments of data structures that are sent, received, or stored in the process of negotiating or administering a support contract;

FIGS. 4A-4F are embodiments of user interfaces provided in the process of negotiating or administering a support contract;

FIGS. 5A-5c are a flow diagram of an embodiment of a process for negotiating a virtual support contract;

FIG. 6 is a flow diagram of an embodiment of a process for notifying a customer representative about a contract renewal and negotiation;

FIG. 7 is a block diagram of an embodiment of a computer system environment in which the systems and methods may be executed; and

FIG. 8 is a block diagram of a computer system in which the systems and methods may be executed.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It being understood that various changes may be made in the function and arrangement of elements without departing from the spirit and scope of the appended claims.

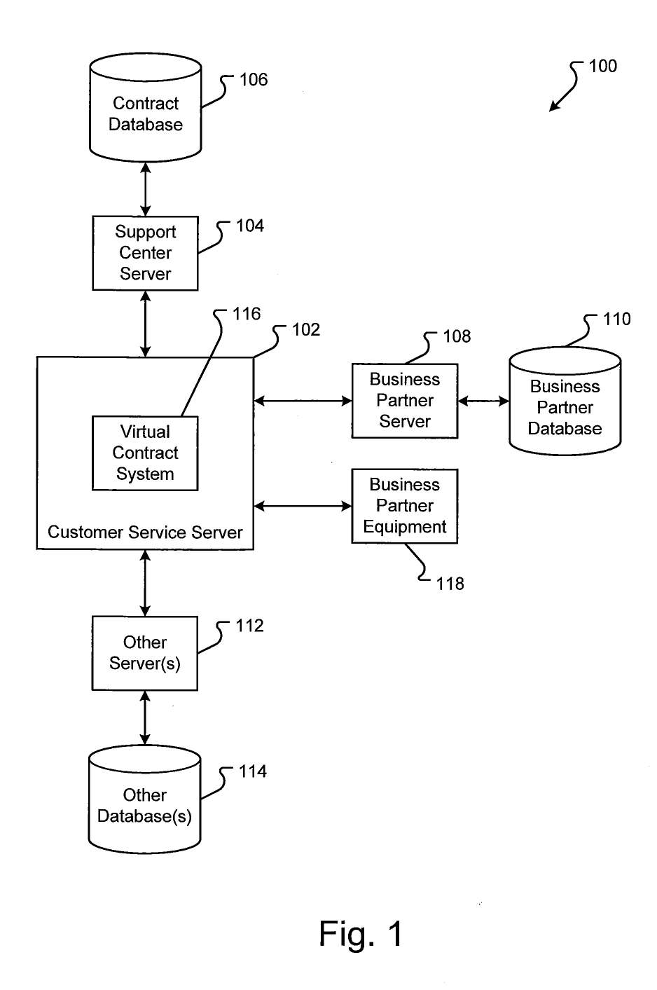

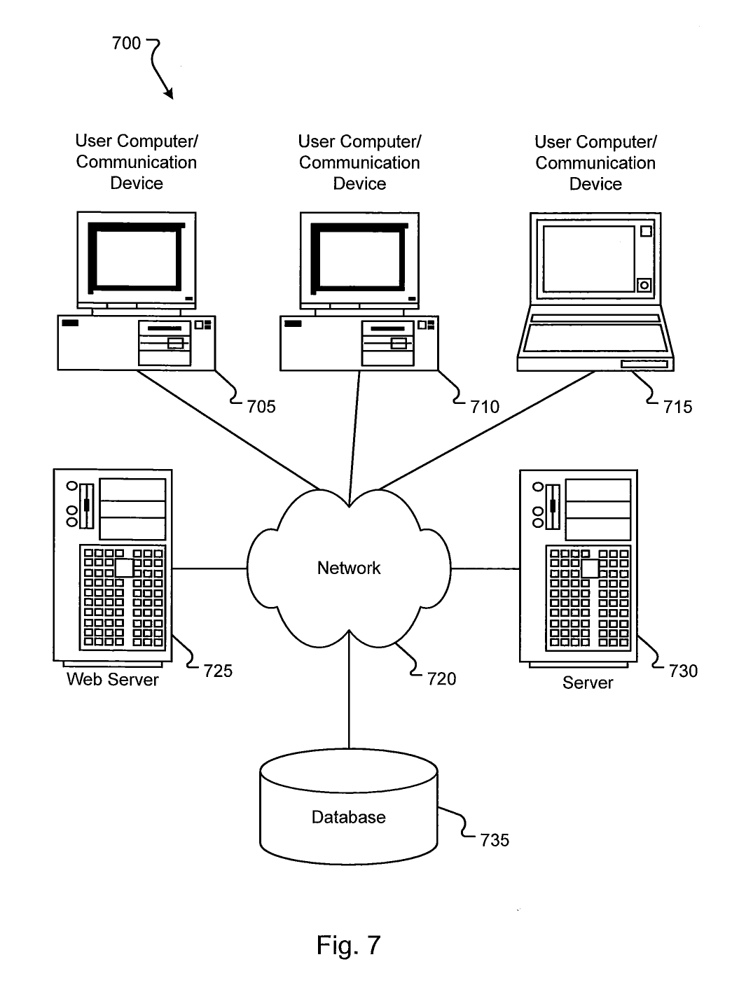

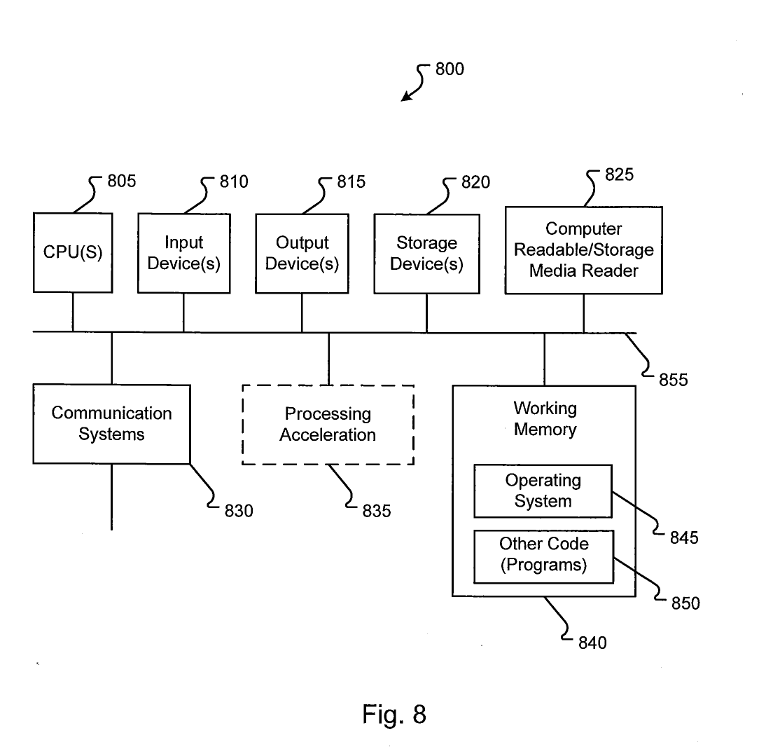

An embodiment of the system 100 to negotiate a contract is shown in FIG. 1. The system 100 can include one or more systems, components, devices, computer systems, or servers which are or may function as computer systems as described in conjunction with FIGS. 7 and 8. The system 100 can include a customer service server 102 that is in communication with a business partner server 108, business partner equipment 118, a support center server 104, and/or one or more other servers 112. Each of the different systems shall be explained in turn hereinafter.

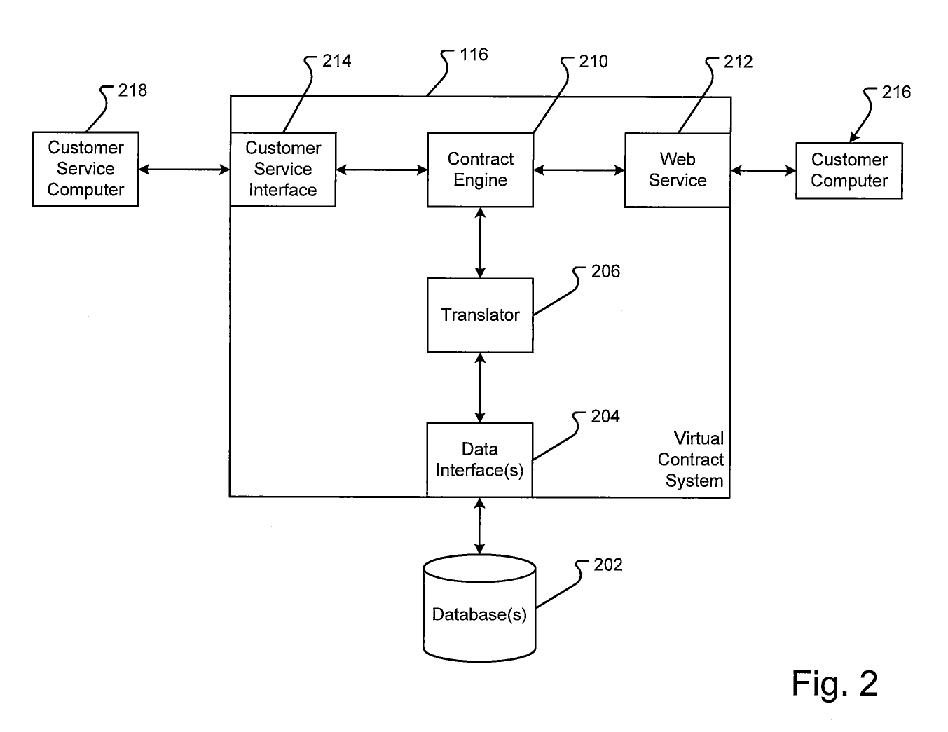

A customer service server is operable to execute a virtual contract system 116. The virtual contract system 116 is operable to facilitate negotiations of a contract between a business partner/customer, a servicer/supplier, and, possibly, one or more third parties. The customer service server 102 can obtain or retrieve data from one or more data sources to provide a virtual contract to both the servicer and customer. The virtual contract can be a conglomeration of one or more contracts that are presently in effect between the servicer and the customer. The virtual contract can be displayed for both the servicer and the customer to facilitate the negotiations. An embodiment of the virtual contract system 116 is described below in conjunction with FIG. 2.

A business partner server 108 can be a computer system that is operated or executed by a BP/customer. The business partner server 108 can provide a display of a virtual contract to a customer. Further, the business partner server 108 can obtain contract information from a business partner database 110. The business partner database 110 can be any database described in conjunction with FIGS. 7 and 8 that is operable to store or provide contract information. Contract information can include any of the terms or conditions of one or more contracts that may be between the BP/customer and the servicer. In embodiments, the contracts can cover the support for one or more items of equipment that are sold, distributed, or manufactured by the servicer. These one or more items of equipment may be business partner equipment 118.

Business partner equipment 118 can be any type of equipment that may require support from the servicer/seller. The servicer/seller can be the entity that executes the customer service server 102 or a third-party that contracts for the services of the customer service server 102. Business partner equipment 118 can include such things as telephone switches, plain old telephone systems (POTS), or other types of equipment that are used in communicating between the business partner and one or more other entities.

The support center server 104 can be another server that is executed by the servicer/seller or a third-party entity contracting with the servicer/seller. The support center server 104 can interface or be in communication with a contract database 106. The contract database 106 can be any database as described in conjunction with FIGS. 7 and 8. The support center server 104 is operable to retrieve or store contract information into the contract database 106. As such, the contract database 106 stores contract information for one or more contracts with one or more business partners.

The customer service server 102 may be in communication with one or more other servers as represented by the other server(s) 112. The other server(s) 112 can be one or more other computer systems executed by other entities or by the enterprise which executes the customer service server. These other servers 112 may be in communication with one or more other databases 114, which may store other contract information. The other server(s) 112 and other database(s) 114 can be associated with one or more third parties, e.g., OEM or third party resellers. As such, the virtual contract system 116 can retrieve contract information from one or more data sources which may include, but are not limited to, the contract database 106, the business partner database 110, and/or the other databases 114.

An embodiment of the virtual contract system 116 is shown in FIG. 2. The virtual contract system 116 may be a software component executable by a processor and stored in memory or may be some type of specially-designed hardware, such as, a field programmable gate array (FPGA) or an application specific integrated circuit (ASIC). The virtual contract system 116 can include one or more modules or components as shown in FIG. 2. In embodiments, the different components or modules may include, but are not limited to, the customer service interface 214, the data interface 204, the web service 212, a translator 206, and/or a contract engine 210. Each of these different components will be explained in turn hereinafter.

A customer service interface 214 is operable to both receive and send information to a customer service computer 218. A customer service computer 218 can be any computer system as described in conjunction with FIGS. 7 and 8. In embodiments, the customer service computer 218 is a personal computer or workstation used by a representative of the enterprise that services equipment or provides a support contract to a customer. A customer service representative can negotiate support contracts with the customer using the customer service computer 218 that is in communication with the virtual contract system 116. As such, the customer service computer 218 can receive and display a virtual contract, and the virtual contract system 116 may receive inputs or other information from the customer service representative through the customer service computer 218. The displays are sent to the customer service computer 218 by the customer service interface 214, and, likewise, the customer service interface 214 can receive the inputs from the customer service computer 218 for the virtual contract system 116.

Similar to the customer service interface 214, a web service 212 may interface with a customer computer 216. The web service 212 can receive inputs from a customer computer 216 or send displays to the customer computer 216. As such, the web service 212 can send a virtual contract display to the customer computer 216 and receive renewal requests from the customer through the customer computer 216. Both the web service 212 and the customer service interface 214 can be any communication interfaces that can communicate with other computer systems using any type of protocol or method of transmission.

The data interface 204 can be one or more interfaces to one or more databases 202. As such, there may be a data interface 204 for each database 202, each data interface 204 specially designed to interface with a certain type of database 202. For example, one data interface 204 may be operable to interface with an SAP database through certain protocols or messages sent to the SAP database. Other database interfaces 204 can communicate with other types of databases including databases offered by Oracle, Microsoft, or other software distributors.

The data interface 204 is operable to store contract data within the databases 202 or retrieve contract information from the databases 202. The databases 202 may be the same or similar to databases described in conjunction with FIG. 7 or 8. In embodiments, the databases 202 represent the contract database 106, the business partner database 110, and/or the other databases 114. The contract information retrieved from the databases 202 may be in a native format and may be sent from the data interface 204 to a translator 206.

A translator 206 can be a component which can translate contract information from a native format into a standard/general format. The translator 206 may take information that may be specific to one type of database, for example, an SAP database, and translate that information into a standard format, for example, an extensible mark-up language (XML). Once translated, the translator 206 can send the information to a contract engine 210.

A contract engine 210 is operable to receive one or more items of contract information and reconcile that contract information into a virtual contract. A contract engine 210 can send the virtual contract to both the customer service interface 214 and the web service 212 to be sent as a display to the customer service computer 218 and the customer computer 216. After providing a virtual contract, the contract engine 210 can receive inputs from the customer computer 216 and the customer service computer 218 to change or modify the virtual contract. The changes may then be incorporated in the virtual contract by the contract engine 210.

Upon completing the virtual contract, the contract engine 210 can store the updated contract information in the one or more databases 202 by sending the general formatted virtual contract back through the translator 206 to be translated into a native format for the data interfaces 204. The updated contract information may then be stored by the data interfaces 204 in the databases 202. As such, the contract engine 210 provides a central component that is able to collect contract information from at least two or more data sources, provide a reconciled virtual contract having the various contract information to both the customer service representative and the customer, receive inputs into the virtual contract, update and finalize the virtual contract, and/or send the updated virtual contract information back to the two or more databases 202.

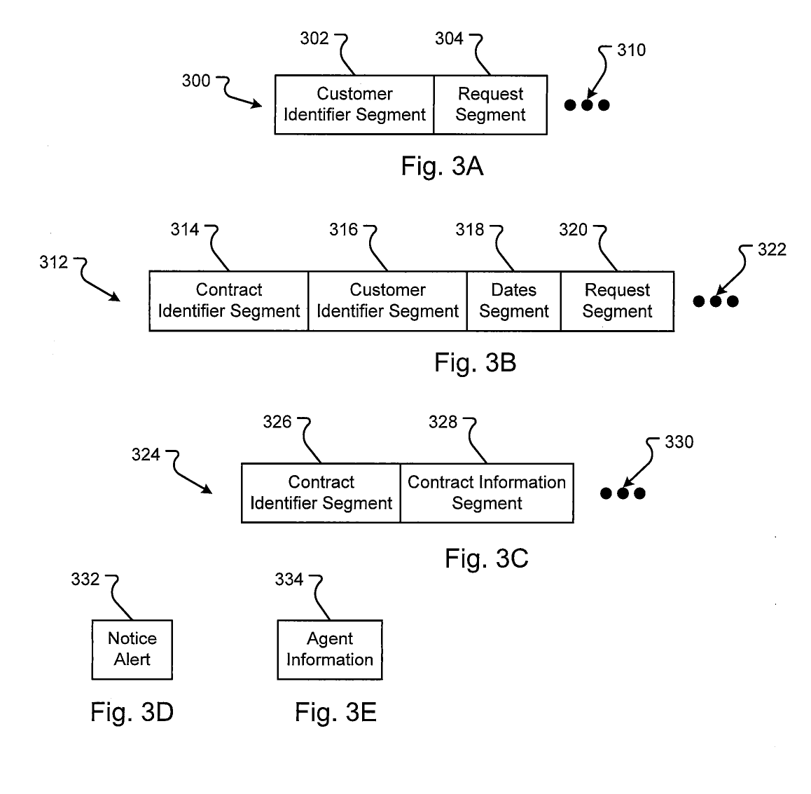

Embodiments of one or more data structures 300, 312, 324, 332, and/or 334 that may be received, sent, or stored while negotiating a virtual contract are shown in FIGS. 3A through 3E. The one or more data structures described in conjunction with FIGS. 3A through 3E can be any type of data structure including an object, a field, a file, a record, or other data structure stored in a relational database, a flat file, an object-oriented database, or other type of database. Here, each field within the data structures will be described as a segment. However, it should be understood by one skilled in the art, the segment can be a field, an attribute, or other type of data structure portion according to the type of data structure used.

An embodiment of a request for customer representative information is shown in data structure 300. In embodiments, the data structure 300 include one or more of, but is not limited to, a customer identifier segment 302 and a request segment 304. The data structure 300 may have more or fewer fields than those shown in FIG. 3A, as represented by ellipses 310. The customer identifier segment 302 can include an identifier for the customer that uniquely identifies that customer in relation to all other customers that interact with the seller/servicer. The customer identifier segment 302 can store a customer identifier, which may be a globally unique identifier (GUID) or some other unique identifier. In other embodiments, the customer identifier segment 302 stores the name, address, phone number, email, or other information for either the customer or a representative of the customer.

The request segment 304 can store a request for information about a customer representative. The request can include a digital display that is displayed on the customer computer 216, which allows the customer to input the representative's information into a data structure. The request segment 304 can include the one or more items of information requested by the servicer, e.g., the name of the representative, the email of the representative, the address of the representative, and/or the phone number for the representative.

Data structure 312 can be a request for contract information. This request for contract information can be the request sent from the contract engine 210 to the one or more databases 202. The contract information request 312 can include one or more of, but is not limited to, a contract identifier segment 314, a customer identifier segment 316, a date segment 318, and/or a request segment 320. The data structure 312 can include more or fewer segments than those shown in FIG. 3B, as represented by the ellipses 312.

The contract identifier segment 314 can store an identifier for one or more contracts. The identifier can be a contract number, a date for the contract, or some other identifier than can uniquely identifier the contract from one or more other contracts. An example of a contract identifier stored in the contract identifier segment 314 can be a GUID that uniquely identifies a contract. It should be noted that each support contract can be specific to a customer and a particular solution (i.e., a set of equipment and/or services provided to solve a specific customer need or problem) for that customer. As such, there can be a contract identifier 314 for each specific customer, equipment, and solution. A customer identifier segment 316 can store a customer identifier that may be the same or similar to the customer identifier stored in the customer identifier segment 302. As such, the customer identifier in the customer identifier segment 316 can uniquely identify the customer and may be a GUID or other information about the customer.

A date segment 318 can store one or more dates that may further describe the contract information that is requested. The dates may be a beginning and ending date for different contracts. The date of a contract, if within the range specified, may be of interest for this contract request. In other embodiments, the date segment 318 may include a date range for one or more contracts that need to be renewed or may lapse during the date range.

Request segment 320 can store one or more requests for contract information. The request segment 320 can include the requests for the required information, including, but not limited to, contract terms, contract conditions, and other information that may be required in negotiating the renewal or changes to the contracts. The request segment 320 can be in a format that is readable by a data source 202. This contract request 312 can be sent by the contract engine 210 through the data interface 204 to the one or more databases 202.

An embodiment of a data structure 324 for sending contract information or representative information to a contract engine 210 is shown in FIG. 3C. The data structure 324 can have more or fewer fields than those shown in FIG. 3C, as represented by ellipses 330. In embodiments, the data structure 324 that sends contract information from the one or more databases 202 to the virtual contract system 116 includes one or more of a contract identifier segment 326 and a contract information segment 328.

Contract identifier segment 326 can be the same or similar to the contract identifier segment 314 that was in data structure 312. Thus, the contract identifier segment 326 relates the contract information in data structure 324 to the data structure 312 sent as a request for contract information. The contract identifier segment 326 can store the one or more identifiers for the one or more contracts that were of interest in the contract information request.

The contract information segment 328 can include the one or more items of contract information that were requested in the request segment 320 or 304 of data structure 312 or 300. This contract information may be entered into a data structure or form provided in the request. As such, the contract information may be provided or listed in a certain order/format as required by the request segment 320. The contract information in the contract information segment 328 can be in the native format for the database and require translation or may be the information that is received by the contract engine 210 after going through the translator 206.

An embodiment of a data structure 332 for a notification or notice alert is shown in FIG. 3D. The notification data structure 332 can include one or more fields as shown in FIG. 3D. The notice alert provides an alert to the customer that one or more contracts may be subject to a renewal or lapse if not renegotiated with the servicer. The notice alert 332 can include the name of the contract, the renewal date, or other information to provide to a customer representative to determine if the customer wishes to negotiate the support contract.

An embodiment of a data structure 334 providing agent information is shown in FIG. 3E. There may be more fields than those shown in FIG. 3E. Regardless, the agent information includes the information for a customer representative that may be sent from a customer computer 216 to the virtual contract system 116 to update any contract information as to who the contact point is for renegotiating a contract. The data structure 334 may be sent in response to receiving data structure 300.

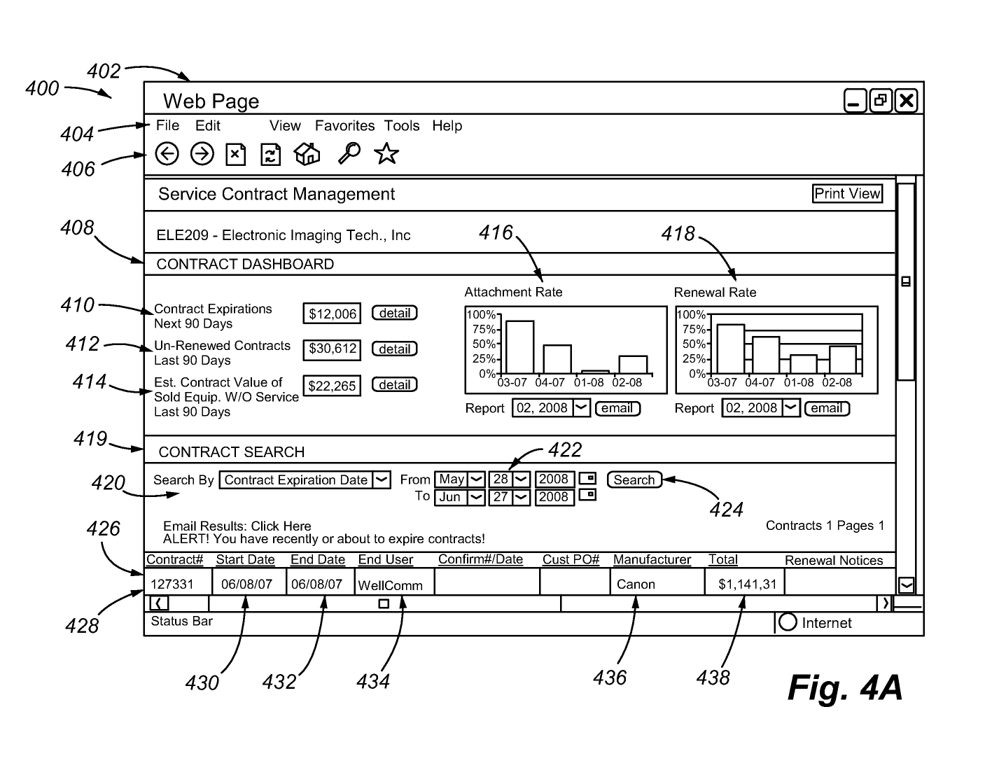

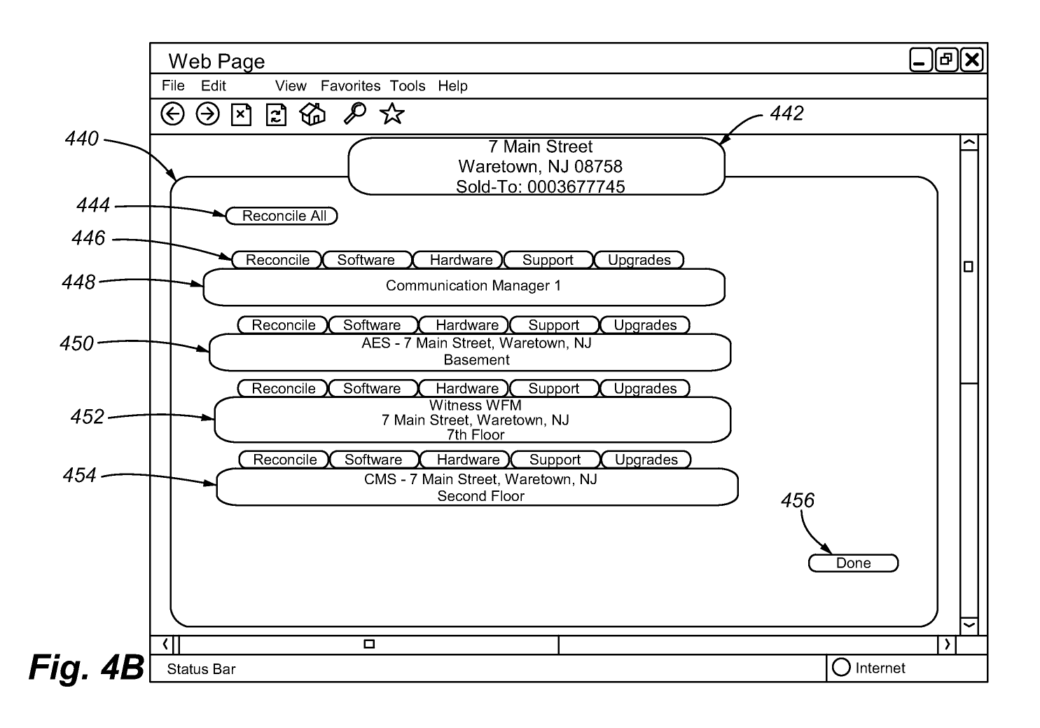

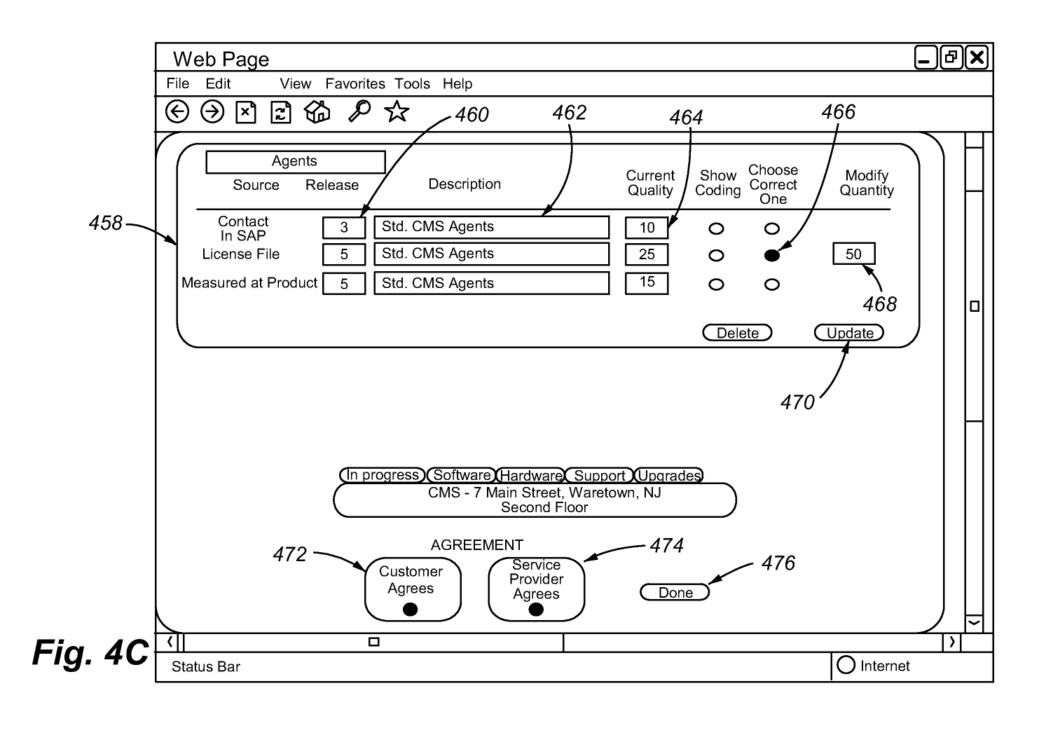

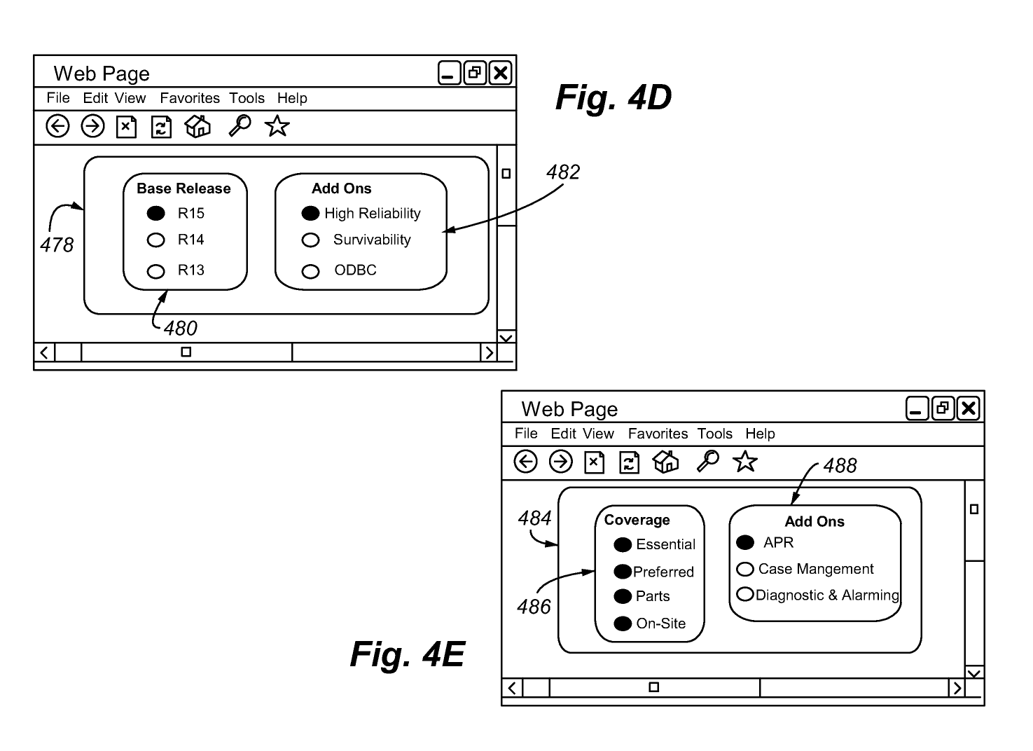

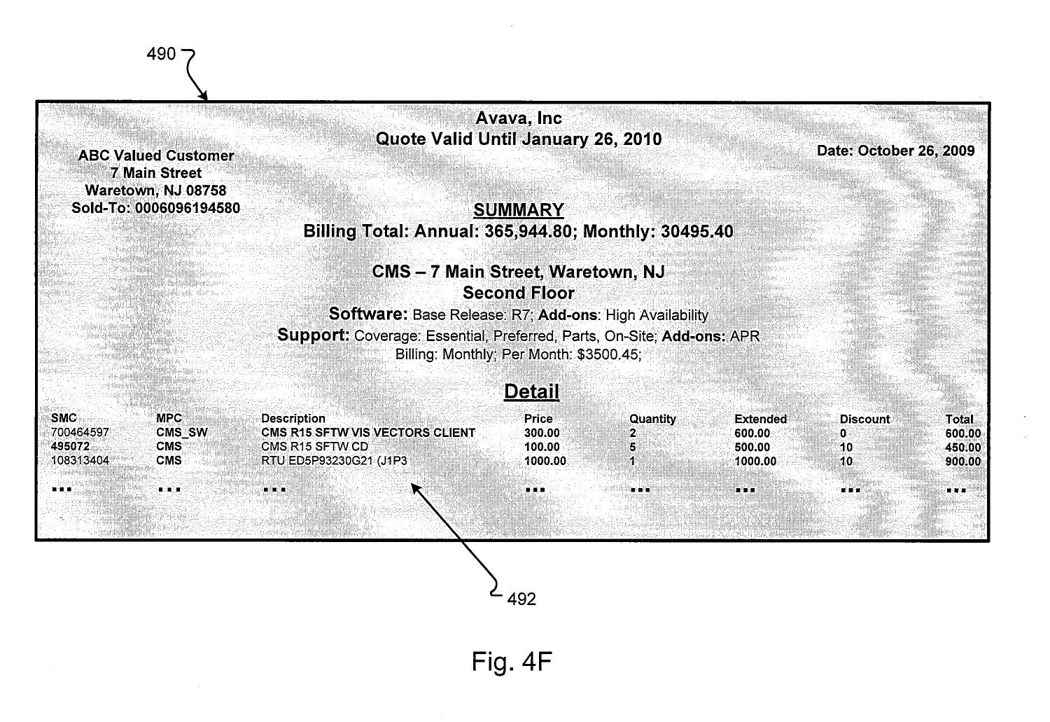

One or more user interfaces are shown in FIGS. 4A through 4F. The user interfaces may include displays that are sent to the customer computer 216 or to the customer service computer 218 and displayed for the customer service representative or customer while renegotiating a support contract. The one or more user interfaces in FIGS. 4A through 4F may be displayed as web pages 402. However, as one skilled in the art will recognize, the user interface displays may be something other than a web page such as a unique interface provided by specially designed software that executes either at the customer service server 102, at the customer computer 216, or at a customer service computer 218. It should also be noted that more or less information can be shown in the several user interfaces shown in FIGS. 4A through 4F. For example, some contract information may be transaction and several line items for each transaction may be shown or may be consolidated into a single line item in other situations. As such, the several user interfaces may be adapted to fit the needs of the customer, seller, or other parties depending on the situation.

User interfaces, described in conjunction with FIGS. 4A through 4F, can include one or more user interface controls or devices that allow a customer server representative or customer to input information into the user interface display to be sent to the contract engine 210. Examples of user interface controls can be menus 404, buttons 406, or other user interface buttons or controls. Each of the different user interfaces will be explained in turn hereinafter.

A contract dashboard user interface 400 is shown in the window 402. The contract dashboard 408 includes one or more items of information that can be displayed for a customer service representative. The contract dashboard 408 may include several different informational displays. For example, one area of the contract dashboard 408 shows a dollar value of contract expirations that will occur within the next 90 days; the dollar value represents that $12,600 worth of contracts are expiring within the next 90 days. Similarly, another display 412 shows the un-renewed contracts over the past 90 days have a dollar value of $30,612. Further, display 414 shows the estimated contract value of equipment that is without service that was sold over the last 90 days. Further information may be displayed as charts or graphs in areas 416 or 418, which show an attachment rate and renewal rate for different products that may be supported by an enterprise.

A contract search section 419 of the window 402 can provide one or more user interface controls that allow a customer service representative to input information to search for expiring contracts. For example, the contract search display 419 can include a pull-down menu 420 that includes a type of search, listed as a contract expiration date search, and one or more date fields 422 (shown from May 28, 2008 through Jun. 27, 2008), which allow a customer service representative to specify date ranges to look for expiring contracts. The search button 424 allows the customer service representative to enter the search and send the search to the contract engine 210.

A results field 426 shows which contracts are returned in response to the search. The contract number is shown in area 428, the start date is shown in area 430, the end date is shown in area 432, the customer and end user of the product is shown in area 434, the manufacture of the products sold to the end user shown in area 436, and the value of the contract is shown in area 438. This display 426 allows the customer service representative to see which contracts may need to be renegotiated and start the negotiation process.

An embodiment of the virtual contract is shown in a virtual contract display in FIG. 4B. The virtual contract can include information about the customer shown in area 442. Reconciled contract information from the databases 202, as compiled by the contract engine 210, can be shown in window 440. The window 440 can include one or more user interface controls, such as, the “Reconcile All” button 444 or the “Reconcile” button 446. The “Reconciled All” button 444 or the “Reconcile” button 446 can receive a selection from a user interface device (e.g., a mouse) to reconcile one or more items of contract information that are compiled within the virtual contract shown in window 440.

One or more items of contract information are shown in areas 448, 450, 452, and/or 454. These areas 448, 450, 452, and/or 454 show the different contract information that may be retrieved and displayed within the virtual contract display. Each one of the areas 448, 450, 452, and/or 454 may show a different contract that may be conglomerated into a single virtual contract display. Another user interface control button, the “Done” button 456, can receive a selection from a user interface device, which provides input from a customer that the virtual contract has been negotiated completely and may be adopted.

A window that may be provided after a user selects a “Reconcile” button 446, is shown in FIG. 4C. Here, the customer and the customer service representative may negotiate terms of a contract within the display. An area 458 can provide terms and conditions for a contract or contract information that may be displayed in areas 448, 450, 452, and/or 454 in the window of FIG. 4B. The information shown in area 458 is exemplary and may include more or fewer items of contract information or different areas depending upon the terms and conditions of the contract. Here, the contract information includes a release number in area 460. A description of the contract information in area 462, a quantity for a number of licenses in area 464, and a user interface control or device 466 that allows a user to correct some item within the contract information.

Another area 468 allows the user to modify some portion of the terms and conditions, for example, the quantity of the licenses provided. Two different user interface devices, the delete and update buttons 470, allow the user to select whether the modified information should be updated. Another set of user interface device 472, 474, and 476 allow the customer and the customer service representative to agree on the changes and complete the update. Thus, the customer can select button 472, which signifies that the customer agrees, while the customer service representative selects the button 474, which signifies that the customer service representative agrees to the changes to the support contract. Once both of the customer and customer service representative agree, a “Done” button 476 can be selected to complete the update of the contract information.

An embodiment of a user interface display 478 for updating or upgrading service for a support contract is shown in FIG. 4D. Here, a user interface area 480 shows the base release of a software product. Another selectable user interface device 482 can receive selections from a user interface device that input what type of add-on features may be desired in a support contract. Similarly, a user interface area 484, as shown in FIG. 4E, may also provide a user-selectable device that allows the user to select different support options in device 486 or device 488. In device 486, different types of coverage for support may be selected by a customer, while different add-ons for the support may be selected in device 488.

A user interface display of a bill that is provided after a negotiation for a support contract is shown in FIG. 4F. The bill 490 can include the one or more different support contracts shown in area 492 that were negotiated through the virtual contract display. Each of the upgrades or changes may incur a cost to the customer that may be shown in the bill 490.

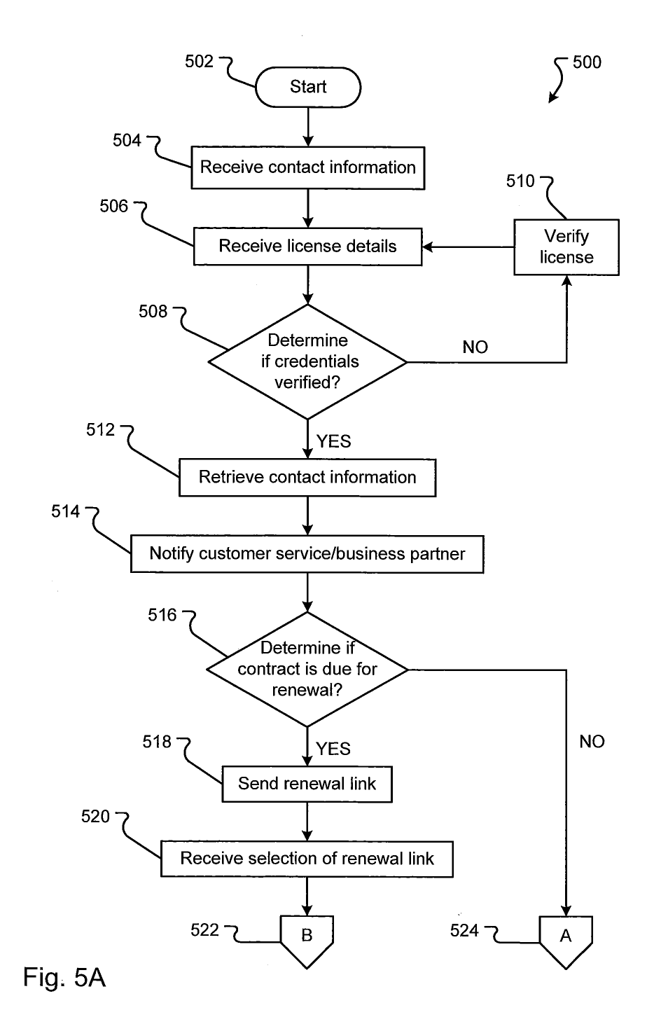

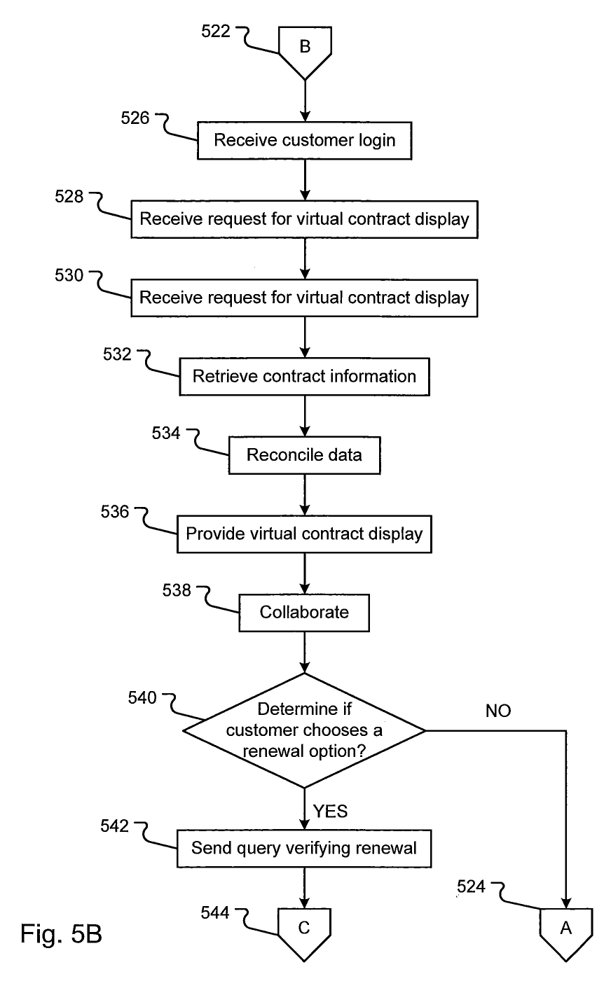

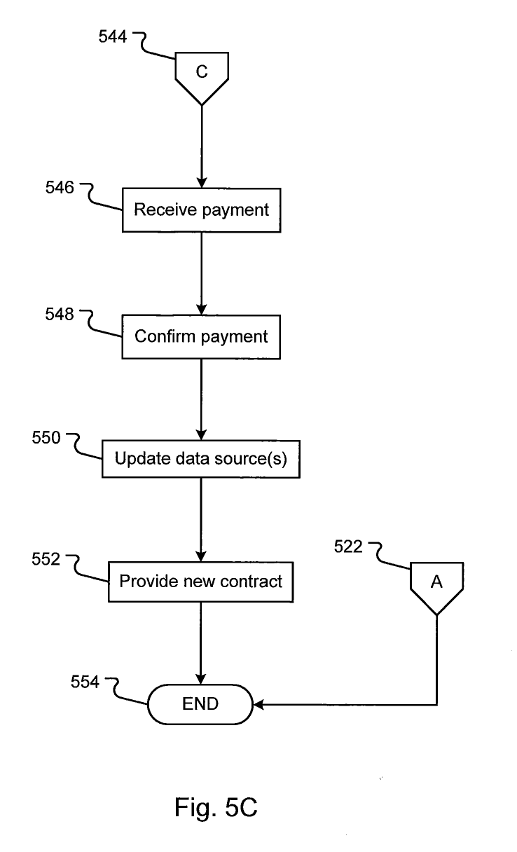

An embodiment of a process 500 for negotiating a contract is shown in FIGS. 5A through 5C. Generally, the method 500 begins with a start operation 502 and terminates with an end operation 554. While a general order for the steps of the method 500 are shown in FIGS. 5A through 5C, the method 500 can include more or fewer steps or arrange the order of the steps differently than those shown in FIGS. 5A through 5C. The method 500 can be executed as a set of computer-executable instructions executed by a computer system and encoded or stored on a computer readable medium. Hereinafter, the method 500 shall be explained with reference to the systems, components, modules, software, data structures, etc. described in conjunction with FIGS. 1-4F.

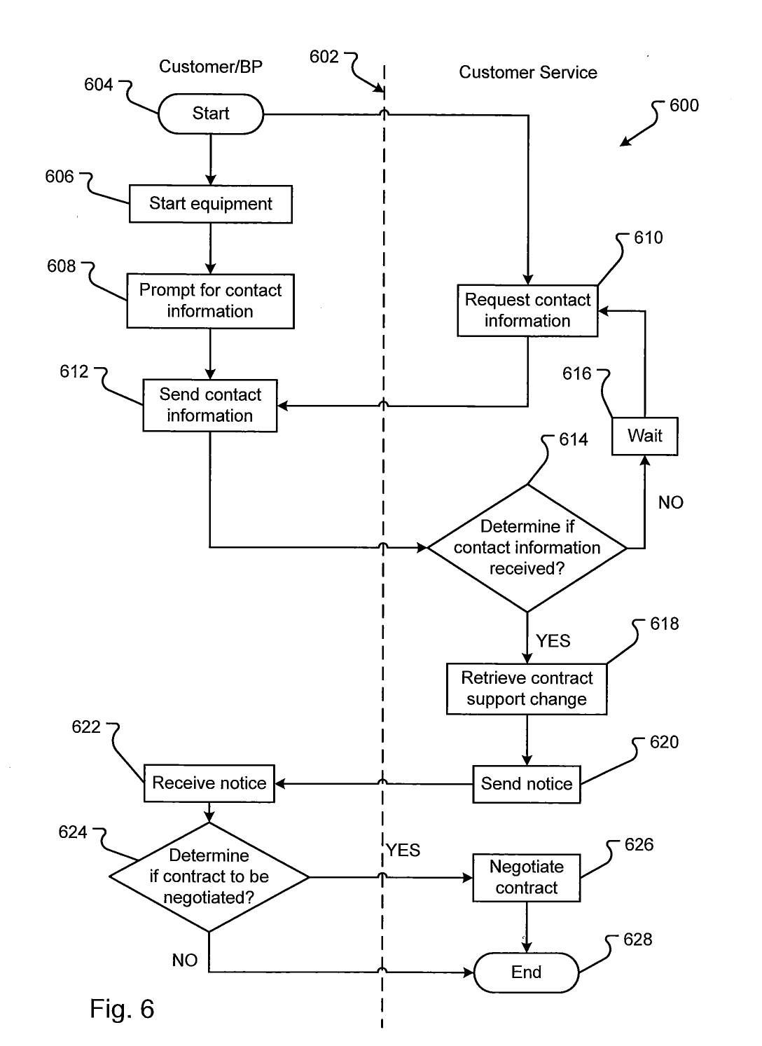

A customer service server 102 receives contact information, in step 504. The contact information can be the information required to contact a representative of an enterprise that may be involved in negotiations for a support contract. This contact information can include a name, a phone number, an address, etc. and may include a logon or password used to identify the representative for the enterprise. The customer service server 102 may also receive license details, in step 506. The license details can include the details for the contract to which the contact information is related. This contract information may be received in a data structure, such as, data structures 324 and/or 334. The contact information and/or license details may be received in a process, such as, that described in conjunction with FIG. 6. The contact information and/or license details may be received by the virtual contract system 116 through the web service 212 and provided to the contract engine 210.

The contract engine 210 may verify the credentials provided in steps 504 and 506, in step 508. In verifying the credentials, the contract engine 210 may compare the received contact information and/or license details with information stored in the contract database 106. Thus, the contract engine 210 may verify the login and password of the representative or other information as being the same as what is stored in the contract database 106. If the information is the same, then the credentials are verified, and step 508 proceeds “YES” to step 512. If the credentials are not verified, then step 508 proceeds “NO” to step 510.

In step 510, the contract engine 210 can verify the license. Verifying the license includes sending one or more requests for further information to a representative of the customer. The further requests may require the representative to enter other information about the license, which only that representative should know. The further details can be entered by the representative and sent to the virtual contract system 116, again in step 506. After receiving the further license details, in step 506, the contract engine 210 can again verify the credentials. If the contract engine 210 is unable to verify credentials after entering more information, the process may end.

At some time after verifying the credentials, the contract engine 210 may retrieve contact information, in step 512. To accomplish a renewal of a support contract, the contract engine 210 can contact the representative of the enterprise involved in the renewal. The contact information may be stored in the contract database 106 and retrieved by the contract engine 210 through the data interface 204. The contact information may then be passed to the contract engine 210 to notify the customer service representative and/or the representative of the customer/business partner of the possibility of renewal of a contract. The retrieval of the contract information, in step 512, may be automatic or prompted by a response to a request from a business representative, such as, by the business representative accessing contract information from the contract dashboard 408.

Using the contact information, the contract engine 210 may send a notification to the customer service representative and/or the customer/business partner, in step 514. Thus, the contract engine 210 may send the contact information to the customer service interface 214 to be packaged in a data structure and sent to the customer service computer 218. After receiving the contact information, the customer service representative and/or the customer/business partner may be determine if a contract is due for renewal, in step 516. The contract, which may be due for renewal, can be associated with the contact information received in step 512. To determine if a contract is due for renewal, the contract engine 210 or the customer service representative may search, such as by the search application 420 to determine if a contract is due for renewal. A contract may be due for renewal if it lapses or ends within a 90 day period from the date of the search. As such, if a search is conducted in user interface area 420, a contract due for renewal may be returned in area 426. If a contract is due for renewal, step 516 may proceed “YES” to step 518. If a contract is not due for renewal, step 516 may proceed “NO,” through off-page connector A 524, to the end operation 554.

If a contract is due for renewal, the virtual contract system 116 may send a renewal link to a representative of the enterprise, in step 518. Thus, the contract engine 210 may receive a request from the customer service computer 218 through customer service interface 214 to send the renewal link to the customer computer 216. The contract engine 210 may compose a renewal link that states the contract information and provides a link back to the virtual contract system 116 through the web service 212. The web interface 212 may send an email, text message, or some other type of electronic message to the customer computer 216 to provide the renewal link.

The representative can, through the customer computer 216, select the renewal link. In selecting the renewal link, the selection is sent back to the web service 212 and received, in step 520. Thus, the renewal link may be a URL or hyperlink, and, when selected, the link directs the browser of the customer computer 216 to interface with the web service 212. The selection of the renewal link is received, in step 520, and the method 500 proceeds through off page connector B 522 to FIG. 5B.

The web service 212 may then provide a request for the customer computer 216 to have the representative login, in step 526. The customer may then login to a website through web service 212, wherein the web service 212 receives the customer login, in step 526. The customer credentials may be verified and passed to the contract engine 210. Upon receiving a verified customer login, the contract engine 210 can receive a request for a virtual contract display from the customer computer 216, in step 528. Thus, after login, the customer computer 216 can select a user interface button to receive a virtual contract display. Further, the contract engine 210 may also receive a second request for virtual contract display from the customer service computer 218 through the customer service interface 214. As such, both parties (e.g., the customer service representative of the seller and the representative of the buyer/BP) that will negotiate the contract can request the virtual contract display.

Upon receiving the one or more requests for the virtual contract display, in step 528 and 530, the contract engine 210 can retrieve contract information, in step 532. As explained previously, the contract engine 210 can interface with the data interface(s) 204 to retrieve contract information from the database(s) 202. Retrieving data from the database(s) 202 can require the contract engine 210 to send a request for information to one or more data interfaces 204 to interface with one or more sources of data. As such, the data interfaces 204 may send a request for data to the business partner database 110, to the business partner equipment 118, to the contract database 106, and/or to one or more other databases 114. Thus, the data interface(s) 204 receives data from multiple sources that may store information about one or more support contracts. The received information is returned to a translator 206 from the one or more data interfaces 204. The translator 206 can translate the database specific information into a general format, such as XML, to be provided to the contract engine 210.

Upon receiving the translated data, the contract engine 210 can reconcile the data, in step 534. In reconciling the data, the contract engine 210 can create a display of the one or more virtual contracts, such as that shown in window 440. The reconciled data provides a similar display for each of the one or more support contracts that may need to be negotiated between the customer and the customer service representative. The virtual contract display 440 can be sent to both the web service 212 and the customer service interface 214 to be sent to the customer computer 216 and the customer service computer 218, in step 536. Thus, the web service 212 creates a web page and sends that web page to the customer computer 216 in response to the request for the virtual contract display. Likewise, the customer service interface 214 may compile or provide a compiled page or user interface to the customer service computer 218 that displays the virtual contract.

After receiving the virtual contract display, the contract engine 210 provides a common interface or common module where both the customer and the customer service representative can collaborate, in step 538. In collaborating, the customer and the customer service representative can review the virtual contract information in the virtual contract display(s) and determine if changes are required. Thus, as either the customer or customer service computer request different views or make changes, those changes and views are reflected on the other computer(s). For example, if the customer computer 216 receives a selection of contract 446 to reconcile in page 440, the contract engine 210 can send page 458 to both the customer computer 216 and the customer service computer 218 to reflect the selection. As such, both the customer and the customer service representative see the same information as the information is being changed. The contract engine 210 may then determine if a customer chooses a renewal option, in step 540. For example, if a customer makes any type of change, which would change the renewal of the contract, either accepting a renewal or changing the services provided, such as by selecting an item in field 446, 472, 474, etc., the contract engine 210 determines that a renewal option has been selected, and step 540 proceeds “YES” to step 542. However, if no renewal option is chosen, step 540 proceeds “NO” through off-page connector 524 to end operation 554 where the contract is not renewed.

If a renewal option is chosen, the contract engine 210 can send a query verifying the renewal, in step 542. For example, the contract engine 210 can send a separate web page through web service 212 to the customer computer 216 asking that the customer computer 216 to verify that the renewal has been selected. In other embodiments, the contract engine 210 may send a separate message, for example, an email or text message, to the customer computer 216 to verify the renewal request through a separate medium. The method 500 then proceeds through off-page connector C 544 to step 546 in Fig. C.

The contract engine 210 may compose a bill, such as that shown in page 490, to send to the customer. The bill 490 can trigger the customer computer 216 to pay for the renewal. The contract engine 210 may then wait for payment. In step 546, the contract engine 210 receives the payment. The contract engine 210 may then confirm the payment, in step 548. As with verifying the renewal option, the contract engine 210 can confirm the payment by sending a separate web page from the web service 212 to the customer computer 216 to confirm the payment. Or, in other embodiments, the contract engine 210 may send a separate message, such as an email or other type of message, to the customer computer 216 to confirm the payment.

After confirming the payment, the contract engine 210 can then update the one or more data sources with the new contract information, in step 550. Thus, the contract engine 210 can take the changes made to the virtual contract and send them through translator 206 to the data interface(s) 204. The translator 206 can translate the general format of the virtual contract to a database unique format. The database unique information may then be sent from the data interface(s) 204 to the business partner equipment 118, the business partner database 110, the contract database 106, or other databases 114 to be stored for future use. Thus, the contract engine 210 ensures that all data sources have the same information after renewal is completed. This information is sent to the other databases such that each of the other databases is provided with the new contract, in step 552.

An embodiment of a process 600 for alerting a customer as to a negotiation of a contract is shown in FIG. 6. Generally, the method 600 begins with a start operation 602 and terminates with an end operation 628. While a general order for the steps of the method 600 are shown in FIG. 6, the method 600 can include more or fewer steps or arrange the order of the steps differently than those shown in FIG. 6. The method 600 can be executed as a set of computer-executable instructions executed by a computer system and encoded or stored on a computer readable medium. Hereinafter, the method 600 shall be explained with reference to the systems, components, modules, software, data structures, etc. described in conjunction with FIGS. 1-4F. Further, some of the steps described in FIG. 6 are performed by a customer/BP (e.g., using a customer computer 216) and other steps are performed by a customer service representative (e.g., using a customer service computer 218), as delineated by line 602.

A customer can start business partner equipment 118, in step 606. In starting the business partner equipment 118, the customer is energizing the one or more pieces of hardware and/or executing software that are subject to a support contract. As part of the start-up routine for the business partner equipment 118, the business partner equipment 118 may prompt the enterprise to enter contact information for a representative responsible for the support contract, in step 608. The contact information can be requested for one or more support contracts that are associated with the business partner equipment 118. The prompt can be a page or user interface that requires someone to enter a name, address, phone number, or other information regarding a representative of the customer, which is responsible for negotiating the renewal of one or more support contracts. In alternative embodiments, the virtual contract system 116 may request the contact information, in step 610. Thus, the contract engine 210 may send a request for contact information through the web service 212 to a customer computer 216. Regardless of whether the business partner equipment 118 prompted the customer for contact information or if the virtual contract system 116 sent a request for contact information, such as request 300, both processes then wait to receive contact information.

The customer computer 216 can send contact information, in step 612. Here, the customer can enter information into either the business partner equipment 118 or in response to a received request to compose data structure 334, which is sent back to the virtual contract system 116. The contract engine 210 can determine if contact information was received, in step 614. If no contact information was received, step 614 may proceed “NO” to step 616 to wait some period of time before requesting contact information, in step 610. For example, if the business partner equipment 118 verifies that the current information is correct, then the user would not enter information for the contact. However, at some point, and possibly periodically, the virtual contract system 116 may request contact information to at least verify that the contact information stored in contact database 106 is correct. If contact information is received, step 614 proceeds “YES” to step 618. Here, the contract engine 210 can retrieve contract support change information, in step 618. A contract support change is a requirement to renew or some other change, such as the possibility of upgrading services that needs to be sent to the enterprise. This information is retrieved and provided to the contract engine 210. The contract engine 210 creates a notice or alert data structure 332 to send to the customer computer 216, in step 620. The data structure 332 is forwarded, by the web service 212 or other system, to the customer computer 216, in step 620. The customer computer 216 receives the notice, in step 622.

The notice may prompt the customer to determine if they wish to renew or renegotiate a contract. The customer computer 216 can determine if the contract is to be negotiated, in step 624. Further, a notice may also be sent to a customer service representative to determine if a contract is to be negotiated. For example, the customer service representative may determine from the contract dashboard 408 whether an update or a renewal is possible for a contract between the enterprise and the customer. If the contract is to be negotiated, step 624 proceeds to “YES” to step 628 where the contract is negotiated, similar to method 500 that discussed in FIGS. 5A through 5C. However, if the contract is not being negotiated, such that the customer computer 216 sends a response not to negotiate the contract, step 624 proceeds “NO” to end operations to 628.

In an alternative embodiment, the customer may have multiple contracts with different start and end dates. The user interfaces shown in FIGS. 4A through 4F align the support contracts to one set of dates. However, the user interfaces can show several support contracts, each with different end dates. Another user interface can be provided to the customer with an option to co-terminate all selected contracts to a common end-date. Thus, each support contract will have the same end date and negotiation for renewal of all contracts would occur at the same time. These user interface may also allow a user to select a common bill date for all support contracts where there are multiple bill-dates presently.

The computers, computer systems, servers, devices, and/or components that are described herein and that may execute the processes described herein may be as described in FIGS. 7 and 8. FIG. 7 illustrates a block diagram of a computing environment 700. The system 700 includes one or more computers 705, 710, and 715. The computers 705, 710, and 715 may be general purpose personal computers (including, merely by way of example, personal computers and/or laptop computers running various versions of Microsoft Corp.'s Windows® and/or Apple Corp.'s Macintosh®, Sun Solaris operating systems) and/or workstation computers running any of a variety of commercially-available UNIX® or UNIX-like operating systems. These computers 705, 710, 715 may also have any of a variety of applications, including for example, database client and/or server applications, and web browser applications. Alternatively, the computers 705, 710, and 715 may be any other electronic device, such as a thin-client computer, mobile telephone, mobile device, Internet-enabled mobile telephone, and/or personal digital assistant, capable of communicating via a network (e.g., the network 720 described below) and/or displaying and navigating web pages or other types of electronic data. Although the exemplary system 700 is shown with three computers, any number of computers may be supported.

System 700 further includes a network 720. The network 720 may can be any type of network familiar to those skilled in the art that can support data communications using any of a variety of commercially-available protocols, including without limitation TCP/IP, SNA, IPX, AppleTalk, and the like. Merely by way of example, the network 720 maybe a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, the Bluetooth® protocol known in the art, and/or any other wireless protocol); and/or any combination of these and/or other networks.

The system 700 may also include one or more server computers 725 and 730. The server computers 725 and/or 730 can represent the customer service server 102. One server may be a web server 725, which may be used to process requests for web pages or other electronic documents from user computers 705, 710, and 720. The web server can be running an operating system including any of those discussed above, as well as any commercially-available server operating systems. The web server 725 can also run a variety of server applications, including HTTP servers, FTP servers, CGI servers, database servers, Java servers, and the like. In some instances, the web server 725 may publish operations available operations as one or more web services.

The system 700 may also include one or more file and or/application servers 730, which can, in addition to an operating system, include one or more applications accessible by a client running on one or more of the user computers 705, 710, 715. The server(s) 730 may be one or more general purpose computers capable of executing programs or scripts in response to the user computers 705, 710 and 715. As one example, the server may execute one or more web applications. The web application may be implemented as one or more scripts or programs written in any programming language, such as Java™, C, C# or C++, and/or any scripting language, such as Perl, Python, or TCL, as well as combinations of any programming/scripting languages. The application server(s) 730 may also include database servers, including without limitation those commercially available from Oracle, Microsoft, Sybase™, IBM™ and the like, which can process requests from database clients running on a user computer 705.

The web pages created by the web application server 730 may be forwarded to a user computer 705 via a web server 725. Similarly, the web server 725 may be able to receive web page requests, web services invocations, and/or input data from a user computer 705 and can forward the web page requests and/or input data to the web application server 730. In further embodiments, the server 730 may function as a file server. Although for ease of description, FIG. 7 illustrates a separate web server 725 and file/application server 730, those skilled in the art will recognize that the functions described with respect to servers 725, 730 may be performed by a single server and/or a plurality of specialized servers, depending on implementation-specific needs and parameters.

The system 700 may also include a database 735. The database 735 may reside in a variety of locations. By way of example, database 735 may reside on a storage medium local to (and/or resident in) one or more of the computers 705, 710, 715, 725, 730. Alternatively, it may be remote from any or all of the computers 705, 710, 715, 725, 730, and in communication (e.g., via the network 720) with one or more of these. In a particular set of embodiments, the database 735 may reside in a storage-area network (“SAN”) familiar to those skilled in the art. Similarly, any necessary files for performing the functions attributed to the computers 705, 710, 715, 725, 730 may be stored locally on the respective computer and/or remotely, as appropriate. In one set of embodiments, the database 735 may be a relational database, such as Oracle 10i®, that is adapted to store, update, and retrieve data in response to SQL-formatted commands.

FIG. 8 illustrates one embodiment of a computer system 800 upon which the test system may be deployed or executed. The computer system 800 is shown comprising hardware elements that may be electrically coupled via a bus 855. The hardware elements may include one or more central processing units (CPUs) 805; one or more input devices 810 (e.g., a mouse, a keyboard, etc.); and one or more output devices 815 (e.g., a display device, a printer, etc.). The computer system 800 may also include one or more storage devices 820. By way of example, storage device(s) 820 may be disk drives, optical storage devices, solid-state storage devices, such as a random access memory (“RAM”) and/or a read-only memory (“ROM”), which can be programmable, flash-updateable, and/or the like.

The computer system 800 may additionally include a computer-readable storage media reader 825; a communications system 830 (e.g., a modem, a network card (wireless or wired), an infra-red communication device, etc.); and working memory 840, which may include RAM and ROM devices as described above. In some embodiments, the computer system 800 may also include a processing acceleration unit 835, which can include a DSP, a special-purpose processor and/or the like

The computer-readable storage media reader 825 can further be connected to a computer-readable storage medium, together (and, optionally, in combination with storage device(s) 820) comprehensively representing remote, local, fixed, and/or removable storage devices plus storage media for temporarily and/or more permanently containing computer-readable information. The communications system 830 may permit data to be exchanged with the network 820 and/or any other computer described above with respect to the system 800. Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices, and/or other machine readable mediums for storing information.

The computer system 800 may also comprise software elements, shown as being currently located within a working memory 840, including an operating system 845 and/or other code 850, such as program code implementing the components and software described herein. It should be appreciated that alternate embodiments of a computer system 800 may have numerous variations from that described above. For example, customized hardware might also be used and/or particular elements might be implemented in hardware, software (including portable software, such as applets), or both. Further, connection to other computing devices such as network input/output devices may be employed.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of computer-readable or machine-executable instructions, which may be used to cause a machine, such as a general-purpose or special-purpose processor or logic circuits programmed with the instructions to perform the methods. These computer-readable or machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of computer-readable or machine-readable mediums suitable for storing electronic instructions. Alternatively, the methods may be performed by a combination of hardware and software.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Also, it is noted that the embodiments were described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

While illustrative embodiments have been described in detail herein, it is to be understood that the inventive concepts may be otherwise variously embodied and employed, and that the appended claims are intended to be construed to include such variations, except as limited by the prior art.

What is claimed is:

1. A method for negotiating a contract, the method comprising:
receiving, by a virtual contract system executed on a server, contract information;
providing, by the virtual contract system, a virtual contract display to at least a servicer and a customer to conduct a negotiation regarding the contract;
determining, by the virtual contract system, if the customer chooses a renewal option;
if the customer chooses the renewal option, updating, by the virtual contract system, contract information with renewal information;
providing, by the virtual contract system, a renewed contract with the renewal information; and
if the customer does not choose the renewal option, ending the negotiation.

2. The method as defined in claim 1, wherein the contract information is received from two or more data sources.

3. The method as defined in claim 2, wherein at least one of the data sources is one of a contract database, a business partner database, and a business partner equipment.

4. The method as defined in claim 2, wherein receiving the contract information comprises:
translating, by the virtual contract system, the contract information; and
reconciling, by the virtual contract system, the translated contract information.

5. The method as defined in claim 1, wherein providing the virtual contract display further comprises:
sending, by the virtual contract system, a renewal link to the customer;
receiving, by the virtual contract system, a selection of the renewal link;
receiving, by the virtual contract system, a customer login; and
receiving, by the virtual contract system, a request for the virtual contract display.

6. The method as defined in claim 1, further comprising:
request, by the virtual contract system, contact information for a representative of the customer;
send, by the virtual contract system, a notification to the representative, wherein the notification regards a change to the contract.

7. The method as defined in claim 6, wherein the change is one of a group consisting of a cancellation of support for a product, a change to support for a product, an upgrade to a product, an upgrade to support of a product, and an offer for a new product.

8. The method as defined in claim 1, wherein the virtual contract display is provided to the customer by a web service.

9. A customer service server comprising:
a memory operable to store one or more computer executable instructions;
a processor in communication with the memory, the processor operable to execute the one or more computer executable instructions, wherein executing the one or more computer executable instructions causes the processor to execute a virtual contract system, the virtual contract system comprising:
a data interface operable to:
retrieve contract information from two or more data sources;
store contract information for an updated contract into the two or more data sources;
a contract engine operable to:
reconcile the contract information into a virtual contract;
generated a virtual contract display of the virtual contract;
update the virtual contract based on at least one renewal option received from a customer regarding the virtual contract;
provide the updated contract based on the update of the virtual contract;
a web service operable to:
send the virtual contract display to the customer;
receive the at least one renewal option from a customer regarding the virtual contract; and
a customer service interface operable to send the virtual contract display to the customer service representative.

10. The customer service server as defined in claim 9, wherein the contract information is in a native format, and the test system further comprises a translator operable to translate the native format contract information into a standard format.

11. The customer service server as defined in claim 9, the contract engine 210 further operable to:
retrieve a change to the contract; and
generate a notice for the customer about the change.

12. The customer service server as defined in claim 9, wherein the web service is in communication with a customer equipment, wherein the customer equipment is operable to request representative information and send the representative information to the web service, and wherein the notice is sent by the web service to a representative listed in the representative information.

13. The customer service server as defined in claim 10, wherein the change is one of a group consisting of a cancellation of support for a product, a change to support for a product, an upgrade to a product, an upgrade to support of a product, and an offer for a new product.

14. The customer service server as defined in claim 9, at least one of the data sources is one of a contract database, a business partner database, and a business partner equipment.

15. A computer readable medium, stored on a tangible medium, having stored thereon computer-executable instructions when executed by a processor cause the processor to execute a method for negotiating a contract, the computer-executable instructions comprising:
instructions to retrieve contract information from two or more data sources;
instructions to provide a virtual contract display to at least a servicer and a customer to conduct a negotiation regarding the contract, wherein the virtual contract display displays the contract information from two or more data sources;
instructions to receive a renewal option from the customer;
instructions to update the contract information with renewal information; and
instructions to provide a renewed contract with the renewal information.

16. The computer readable medium as defined in claim 15, wherein at least one of the data sources is one of a contract database, a business partner database, and a business partner equipment.

17. The computer readable medium as defined in claim 15, wherein instructions to retrieve contract information comprises:
instructions to translate the contract information; and
instructions to reconcile the translated contract information into the virtual contract.

18. The computer readable medium as defined in claim 15, wherein instructions to provide a virtual contract display comprises:
instructions to send a renewal link to the customer;
instructions to receive a selection of the renewal link;
instructions to receive a customer login; and
instructions to receive a request for the virtual contract display.

19. The computer readable medium as defined in claim 18, further comprising:
instructions to request contract information for a representative of the customer;
instructions to retrieve a change to the contract; and
instructions to send a notification of to the representative, wherein the notification regards the change.

20. The computer readable medium as defined in claim 19, wherein the change is one of a group consisting of a cancellation of support for a product, a change to support for a product, an upgrade to a product, an upgrade to support of a product, and an offer for a new product.
